(19) United States
(12) Patent Application Publication
(10) Pub. No.: US 2011/0059389 A1
(43) Pub. Date: Mar. 10, 2011

(54) Fuel Cell Structure

(76) Inventor: Eric Claude, Fontaine (FR)

(21) Appl. No.: 10/570,452

(22) PCT Filed: Jul. 21, 2004
(86) PCT No.: PCT/FR04/50349

§ 371 Date: Sep. 5, 2008

(30) Foreign Application Priority Data
Sep. 19, 2003 (FR) 03/50574

(51) Int. Cl. H01M 4/66; H01M 8/02

(52) U.S. Cl. 429/522

(57) ABSTRACT

The invention relates to a fuel cell comprising a membrane (1) and an electrode (3; 3′), which is associated with a metallic current collector (5) via a fibrous gas diffusion layer (7) in which the state of the surface of the metallic collector surface in contact with the diffusion layer (7) is adapted to that of the surface of the diffusion layer, typically deformed in a superficial manner by mechanical action.

The present invention relates to fuel cells of the type comprising a solid-state membrane electrolyte and electrodes, each electrode being combined with a metal current collector via a gas diffusion layer based on conducting fibers.

The object of the present invention is more precisely to propose a fuel cell structure of this type designed to reduce the electronic contact resistance between the metal collector and the gas diffusion layer.

To do this, according to one feature of the invention, the surface finish of that surface of the metal collector which is in contact with the diffusion layer is matched to that of the surface of the diffusion layer.

According to more particular features of the invention:
said surface of the metal collector is subjected to a deformation, typically a mechanical deformation, in order to introduce irregularities of dimensions similar to those on the surface of the diffusion layer, with recesses typically of between about 5 μm and 100 μm in size.

Other features and advantages of the present invention will emerge from the following description of embodiments, given by way of illustration but implying no limitation, in conjunction with the appended drawings in which:

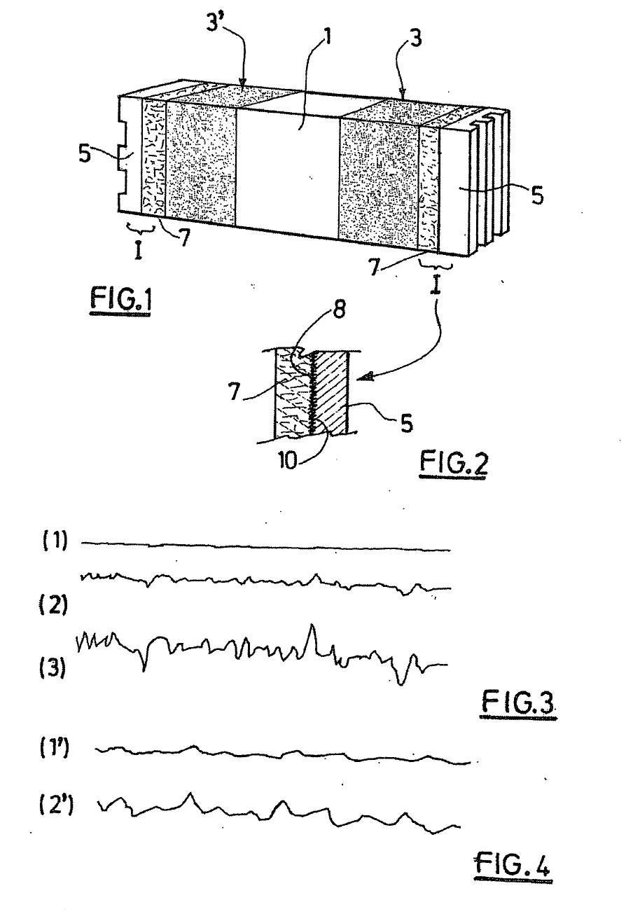

FIG. 1 is a schematic perspective view, not drawn to scale, of a cell element of a fuel cell according to the invention;

FIG. 2 is an enlarged schematic view in partial cross section of the interface zone (I) between the metal collector and the gas diffusion layer;

FIG. 3 shows, on a macroscopic scale, three different surface finishes of the metal collector; and

FIG. 4 shows, on the scale of FIG. 3, morphologies of the diffusion layer surface.

As shown schematically in FIG. 1, a cell element of a fuel cell according to the invention essentially comprises a proton-exchange membrane 1 against the faces of which active layers are applied, comprising a catalyst, such as a platinum catalyst, these being associated with a cathode 3 and an anode 3′ respectively, said cathode and anode themselves being associated on the outside with bipolar metal blocks 5 with interposition of a fibrous gas diffusion layer 7.

As shown schematically in FIG. 2, the interface (I) between a porous layer 7 and a metal block 5 is formed by pressure contact between the opposed faces 8 and 10 of these two elements respectively.

Conventionally, the contact surface 8 of the metal collector 5, typically made of stainless steel, has a very smooth surface finish, obtained by polished or bright annealing, as depicted by the line 1 in FIG. 3.

In contrast, the gas diffusion layer 7 is made in the form of a fibrous fabric or felt, typically made from carbon fibers, which has an intrinsic external roughness with relatively rigid moderate irregularities, as shown by the profile 1′ in FIG. 4 in the case of felts, or with pronounced irregularities, as shown by the profile 2′ in FIG. 4 in the case of fabrics, which are generally flexible and elastic.

According to the invention, to obtain, on the microscopic scale, the highest effective area of contact between the two elements 5 and 7, the surface finish of the contact surface 8 of the plate forming the metal collector 5 is modified, by mechanical or electromechanical surface deformation, in order for it also to have moderate irregularities, as represented by the profile 2 in FIG. 3, typically with recesses of around 5 μm to 15 μm in size, or large irregularities, as shown by the profile 3 in FIG. 3 with recesses typically around 50 to 100 μm in size, corresponding approximately to the irregularities of the diffusion layer, in this case 1′ and 2′ respectively.

With such matching of the morphologies of the contacting surfaces, the performance of each cell element of the fuel cell is improved, either electrically in terms of power and efficiency for a given current density and for a given mechanical assembly pressure, or mechanically, with a lower assembly pressure needed to obtain the same power and the same efficiency for a given current density.

The surface deformation of the metal contact surface may be achieved in various ways, for instance by a treatment, prior or subsequent to the stamping of the plate forming the metal collector, for example a sandblasting treatment or the use of a file with controlled roughness or the use of glass paper. The roughness state of the metal surface may also be obtained during the stamping operation by modifying the surface finish of the stamping tool, for example by electrical discharge machining.

In all cases, the deformation is modulated in order to give a specified level of roughness obtained by a judicious choice of the sand particles, the grade of file, the grit size of the abrasive paper or the roughness of the stamping tool surface.

Although the invention has been described in relation to particular embodiments, it is not limited thereto but is capable of modifications and variations that will be apparent to those skilled in the art within the context of the appended claims.

1-5. (canceled)

6. A fuel cell comprising, on each side of a membrane, an electrode joined to a metal current collector via a fibrous gas diffusion layer, in which cell the surface of the metal collector in contact with the diffusion layer is subjected to deformations in order to introduce irregularities similar to those on the surface of the diffusion layer.

7. The fuel cell as claimed in claim 6, characterized in that the deformation is carried out by mechanical abrasion.

8. The fuel cell as claimed in claim 6, characterized in that the deformation is carried out by stamping.

9. The fuel cell as claimed in claim 6, characterized in that the irregularities comprise recesses between about 5 and 100 μm in size.

10. The fuel cell as claimed in claim 6, characterized in that the metal collector (5) is made of stainless steel.
